(19) United States
(12) Patent Application Publication
(10) Pub. No.: US 2019/0151688 A1
(43) Pub. Date: May 23, 2019

(54) New Full-face Mask with Much Larger Look-down Field of Vision

(71) Applicant: Quan Peng, Dongtai City (CN)

(72) Inventor: Quan Peng, Dongtai City (CN)

(21) Appl. No.: 16/191,479

(22) Filed: Nov. 15, 2018

(30) Foreign Application Priority Data
Nov. 17, 2017 (CN) 201711149034.7

(51) Int. Cl. A62B 18/08; A62B 18/02

(52) U.S. Cl. CPC A62B 18/082; A62B 18/02

(57) ABSTRACT

This invention refers to a tight-fitting full-face mask for respiratory protection, which can provide a much larger look-down field of vision as a new model. It can be applied to industrial compressed air respirator with a self-contained open circuit, positive-pressure firefighting respirator, oxygen respirator, gas mask, and middle-pressure tube respirator. This has helped to address the problems that existing wide-field full-face masks can only provide a small field of vision and users cannot observe surrounding environments well with it. Besides breaking through traditional structure of existing wide-field full-face masks, this application reduces interface area in the middle of the bottom and moves it downwards to the greatest extent. The distance H is designed to be 137 mm-170 mm (except transitions) and distance L to 65 mm-98 mm for the purpose of obtaining a brand-new model. In this way, point A will be lowered and brought closer to face to improve look-down field of vision for the sake of super-wide field of vision which users expect for.

### TECHNICAL FIELD

This application refers to a tight-fitting full-face mask for respiratory protection, which can provide a much larger look-down field of vision as a new model. It can be applied to industrial compressed air respirator with a self-contained open circuit, positive-pressure firefighting respirator, oxygen respirator, gas mask and middle-pressure tube respirator.

### TECHNICAL BACKGROUND

As an important part of respiratory protection product, full-face mask working with airway tube, canister and air supply valve can protect user's respiratory organs, eyes, facial skin effectively, as well as prevent people from being hurt by harmful substances like toxic gas, dust and bacteria. Therefore, it is universally applied to various fields, including petroleum, chemical engineering, mining, metallurgy, military science, fire protection, rescue and relief work, epidemic prevention, technology and environmental protection.

Full-face mask is composed of visual lens, main body of soft sealing gel, hoop, mouth-nose mask, inlet, expiratory valve, interphone, headband or hood, tightening buckle.

According to visual lens, there are three types of full-face masks. The first type is binocular full-face mask, with two rounded and nearly-rounded lens for eyes on the mask.

The second type is monocular full-face mask, which is only furnished with a large visual lens. In addition to a tightening area around, the lens is designed with a valid visual area in the middle. The main body of soft sealing gel beneath tightening frame of visual lens is equipped with an inlet, interphone, expiratory valve, etc.

The third type is compound full-face mask with larger field of vision. Besides the tightening area around the lens and the valid visual area, it also consists of the interface installing area beneath the lens as well as the inlet, interphone and expiratory valve at the interface installing area. Without the hoop and partial soft sealing gel between interface and lens in the monocular full-face mask, this type of full-face mask provides a much larger field of vision. Therefore, it is termed as wide-field full-face mask.

According to definitions, Point A is an intersection outside the middle part between interface installing area and valid visual area at the lower part of the lens. Point B is the highest point outside the middle of valid visual area. Point C is in the middle of the intersection between the lower part of interface installing area and tightening area. H refers to the distance between Point A and Point B, and L to the distance between Point A and Point C. According to existing wide-field full-face masks in the market, H tends to be smaller than 130 mm and L larger than 103, which leads to a small look-down angle, i.e., 35°, at point A. On this occasion, there will be a small look-down field of vision under full-face mask. Then, the users will have problems observing surrounding environment and spend more time reacting to danger, which will lead to some hazards.

### CONTENTS OF INVENTION

To tackle technical problems above, this application puts forward a new full-face mask with a much larger look-down field of vision which can break through traditional structure of wide-field full-face mask. Below is the technical scheme.

The new full-face mask with a much larger look-down field of vision is equipped with a compound lens comprised of valid visual area, interface installing area and tightening area. Point A is an intersection outside the middle part between interface installing area and valid visual area at the lower part of the lens. Point B is the highest point outside the middle of valid visual area. Point C is in the middle of the intersection between the lower part of interface installing area and tightening area. H refers to the distance between Point A and Point B, and L to the distance between Point A and Point C. According to design, H=137 mm-170 mm and L=65 mm-98 mm. Such design can be achieved by reducing interface area in the middle of the bottom and moving it backwards.

In this application, the mouth-nose mask is re-designed according to standard head model, and nose position is designed in accordance with the lowest position of the intersection between two eyes so that the look-down field of vision will not be smaller than the lens' greatest look-down field of vision.

As for the full-face mask in this application, the curved surface of valid visual area's lens consists of cylindrical surface, conical surface and approximate spherical surface.

The full-face mask in this application can be applied to industrial compressed air respirator with a self-contained open circuit, positive-pressure firefighting respirator, oxygen respirator, gas mask and middle-pressure tube respirator.

In this application, the new full-face mask with a much larger look-down field of vision is simulated with medium-sized head model. The look-down visual angle α of Point A lies between 40 and 58 degrees, which has improved look-down field of vision greatly and given rise to a super large field of vision which users always expect for.

### EXPLANATIONS ON FIGURES

Detailed descriptions on non-restrictive examples are conducted according to figures below, which can make other features, aims and advantages of this application more clear.

FIG. 1 Plan sketch for good example of new full-face mask with a much larger look-down field of vision in this application;

FIG. 2 Schematic diagram for critical points shown by new full-face mask with a much larger look-down field of vision;

FIG. 3 Structural diagram for new full-face mask with a much larger look-down field of vision in this application;

FIG. 4 Sectional view for new full-face mask with a much larger look-down field of vision in this application;

FIG. 5 Structural diagram for mist deflector in this application.

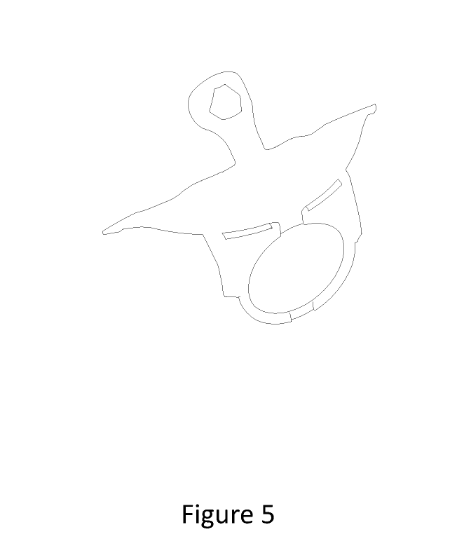

### DESCRIPTIONS ON EVERY PART IN THE FIGURES

1—inlet;
2—mist deflector;
3—mouth-nose mask;
4—lens;
5—main body of soft sealing gel;
6—hoop;
7—medium-sized standard head model;
12—pupil's position;
13—interface installing area;
14—valid visual area;
15—horizontal line of sight;
16—maximum low line of sight.

### SPECIFIC IMPLEMENTATION MODE

Detailed explanations on this application will be made according to examples. The examples below will help technicians in this field to understand this application better, but will not impose any constraints over this application. It is worth noticing that any changes and improvements made by ordinary technicians in this field on the premise of following the thoughts of this application shall fall within the protective scope of this application.

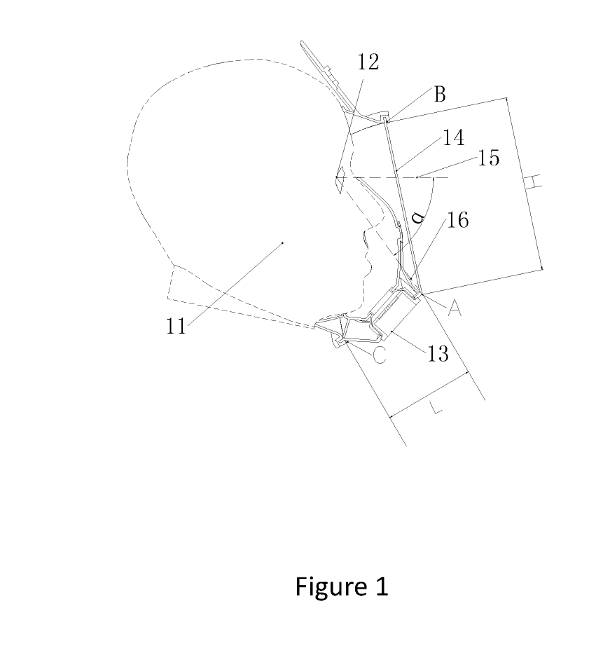

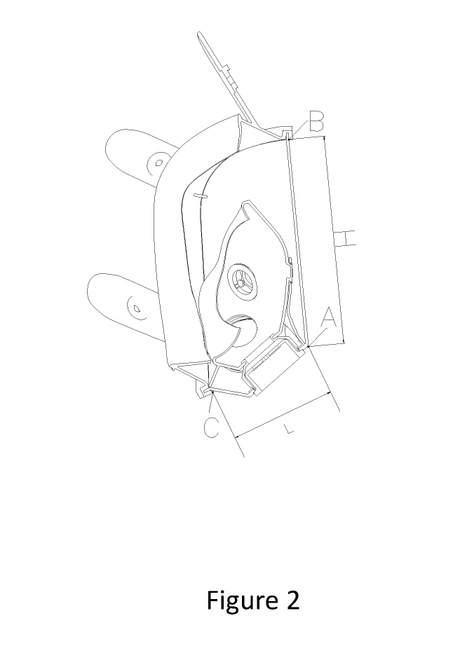

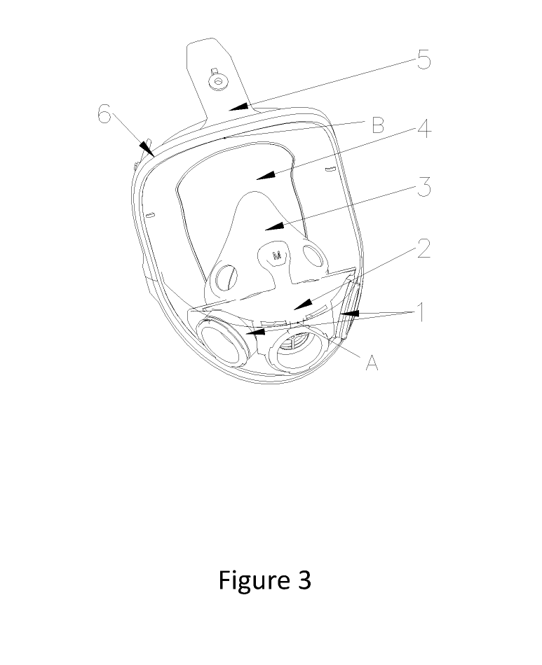

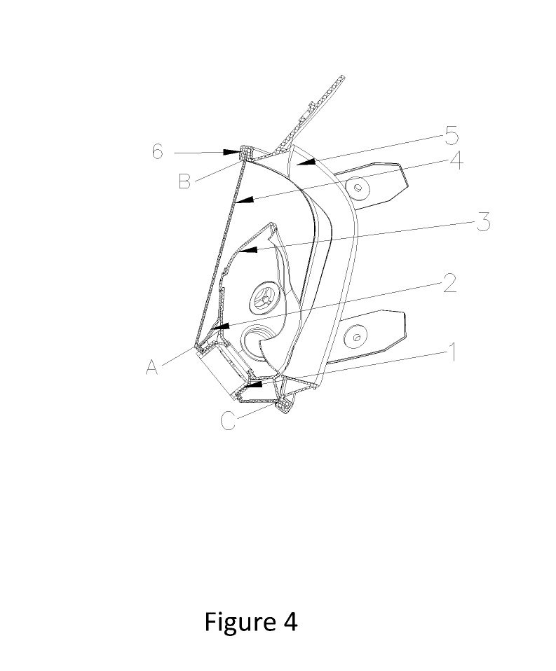

According to FIGS. 1-4, the new full-face mask with a much larger look-down field of vision is equipped with a compound lens 4. It is comprised of valid visual area 14, interface installing area 13 and tightening area. Point A is an intersection outside the middle part between interface installing area and valid visual area at the lower part of the lens. Point B is the highest point outside the middle of valid visual area. Point C is in the middle of the intersection between the lower part of interface installing area and tightening area. H refers to the distance between Point A and Point B, and L to the distance between Point A and Point C. According to design, H=152 mm and L=83 mm.

Apart from these, the full-face mask above also includes functional interfaces 1 like expiratory valve and inlet, mouth-nose mask 3, main body of soft sealing gel 5, hoop 6, headband or hood, and mist deflector 2. The functional interface 1 is connected with mouth-nose mask 3 at one end and with lens 4 at the other. With the mist deflector 2 located between functional interface 1 and lens 4, the main body of soft sealing gel is wrapped around lens 4 and then tightened with hoop 6.

According to FIG. 1, the new full-face mask in this example is simulated with medium-sized head model, which includes pupil's position 12, horizontal line of sight 15, and maximum low line of sight 16. The look-down angle α of A point is 51°, which has given rise to a much larger look-down field of vision.

In this application, the mouth-nose mask is re-designed according to standard head model, and nose position is designed in accordance with the lowest position of the intersection between two eyes so that the look-down field of vision will not be smaller than the lens' greatest look-down field of vision.

As for the full-face mask with a much larger look-down field of vision, the curved surface of valid visual area's lens consists of cylindrical surface, conical surface and approximate spherical surface.

The full-face mask in this application can be applied to industrial compressed air respirator with a self-contained open circuit, positive-pressure firefighting respirator, oxygen respirator, gas mask and middle-pressure tube respirator.

The above is an explanation on example of this application. There is a need to understand that the specific implementation modes above are not a constraint over this application, and any transformations or modifications made by technicians in this field within the scope of the claim will not have an impact on the contents of this application.

1. The new full-face mask with a much larger look-down field of vision shows following features: the mask is equipped with a compound lens comprised of valid visual area, interface installing area and tightening area. Point A is an intersection outside the middle part between interface installing area and valid visual area at the lower part of the lens. Point B is the highest point outside the middle of valid visual area. Point C is in the middle of the intersection between the lower part of interface installing area and tightening area. H refers to the distance between Point A and Point B, and L to the distance between Point A and Point C. According to design, H=137 mm-170 mm and L=65 mm-98 mm.

2. As described by claim 1, the brand-new full-face mask with a much larger look-down field of vision shows following characteristics: the curved surface of valid visual area's lens consists of cylindrical surface, conical surface and approximate spherical surface.

3. As described by claims 1, the full-face mask above can be applied to gas mask, compressed air respirator with a self-contained open circuit, positive-pressure firefighting respirator, oxygen respirator and middle-pressure tube respirator.

4. As described by claims 2, the full-face mask above can be applied to gas mask, compressed air respirator with a self-contained open circuit, positive-pressure firefighting respirator, oxygen respirator and middle-pressure tube respirator.
